(19) United States
(12) Patent Application Publication
(10) Pub. No.: US 2022/0308413 A1
(43) Pub. Date: Sep. 29, 2022

(54) DISPLAY SUBSTRATE AND DRIVING METHOD AND REPAIRING METHOD THEREOF, DISPLAY PANEL, AND DISPLAY DEVICE

(71) Applicants: Hefei BOE Optoelectronics Technology Co., Ltd., Hefei, Anhui (CN); BOE Technology Group Co., Ltd., Beijing (CN)

(72) Inventors: Liqing Liao, Beijing (CN); Dong Wang, Beijing (CN)

(21) Appl. No.: 17/609,969

(22) PCT Filed: Apr. 8, 2021
(86) PCT No.: PCT/CN2021/085935

§ 371 Date: Nov. 9, 2021

(30) Foreign Application Priority Data
May 30, 2020 (CN) 202010480551.8

(51) Int. Cl. G02F 1/1362; G02F 1/1368; G09G 3/36

(52) U.S. Cl. CPC G02F 1/136286; G02F 1/1368; G02F 1/136259; G09G 3/3677

(57) ABSTRACT

Provided is a display substrate. In the display substrate, wherein orthographic projections, on the base substrate, of the gate electrodes and the gate lines connected to the gate electrodes of the thin film transistors in the pixel units in an nth row are spaced apart from orthographic projections, on the base substrate, of the pixel electrodes in the pixel units in the nth row, and orthographic projections, on the base substrate, of the gate electrodes and the gate lines connected to the gate electrodes of the thin film transistors in the pixel units in an nth row are partly overlapped with the orthographic projections, on the base substrate, of the pixel electrodes in the pixel units in an (n+1)th row.

### CROSS-REFERENCE TO RELATED APPLICATIONS

This application is a 371 of PCT Application No. PCT/CN2021/085935, filed on Apr. 8, 2021, which claims priority to the Chinese Patent Application No. 202010480551.8, filed on May 30, 2020 and entitled “DISPLAY SUBSTRATE AND DRIVING METHOD AND REPAIRING METHOD THEREOF, DISPLAY PANEL, AND DISPLAY DEVICE,” the disclosures of which are incorporated herein by reference in their entireties.

### TECHNICAL FIELD

The present disclosure relates to the field of display technologies, and in particular to a display substrate and a driving method and a repairing method thereof, a display panel, and a display device.

### BACKGROUND

Liquid crystal display (LCD) panels are widely used in the field of display due to their advantages such as high resolution, light weight, low energy consumption and low radiation.

The LCD panel generally includes a base substrate, and a plurality of pixel units disposed on the base substrate, and each pixel unit includes a thin film transistor and a pixel electrode which are connected to each other.

### SUMMARY

The present disclosure provides a display substrate and a driving method and a repairing method thereof, a display panel, and a display device. The technical solutions are as follows.

In one aspect, a display substrate is provided. The display substrate includes:
a base substrate;
a plurality of gate lines and a plurality of data lines, wherein the gate lines and the data lines are disposed on the base substrate; and
a plurality of pixel units disposed on the base substrate and arrayed in row direction and in column direction, wherein each of the pixel units includes a thin film transistor and a pixel electrode, a gate electrode of the thin film transistor being connected to one of the gate lines, a first electrode of the thin film transistor being connected to the one of the data lines, and a second electrode of the thin film transistor being connected to the pixel electrode;
wherein in a scanning direction of the plurality of gate lines, orthographic projections, on the base substrate, of the gate electrodes of the thin film transistors in the pixel units in an n^{th} row and the gate lines connected to the gate electrodes are spaced apart from orthographic projections, on the base substrate, of the pixel electrodes in the pixel units in the n^{th} row, and are overlapped with the orthographic projections, on the base substrate, of the pixel electrodes in the pixel units in an (n+1)^{th} row, n being an integer greater than or equal to 1.

Optionally, orthographic projections, on the base substrate, of the first electrode and the second electrode of the thin film transistor in the pixel unit in the n^{th} row are overlapped with the orthographic projection, on the base substrate, of the pixel electrode in the pixel unit in the (n+1)^{th} row.

Optionally, an orthographic projection, on the base substrate, of the second electrode of the thin film transistor in the pixel unit in the n^{th} row is further overlapped with an orthographic projection, on the base substrate, of the pixel electrode in the pixel unit in the n^{th} row.

Optionally, a spacing between the pixel electrodes in any two adjacent pixel units in a direction of the gate lines is within a first spacing range; and
a spacing between the pixel electrodes in any two adjacent pixel units in a direction of the data lines is within a second spacing range; and
a vertical distance between the pixel electrode and the data line connected to the thin film transistor in each of the pixel units is within a third spacing range.

Optionally, the first spacing range and the second spacing range are both 3 micrometers to 7 micrometers; and the third spacing range is 3 micrometers to 5 micrometers.

Optionally, the pixel electrode in each pixel unit is made of a metal, a reflectivity of the metal material being greater than a reflectivity threshold; or
the display substrate further includes a light-reflective material layer disposed on a side, distal from the base substrate, of the pixel electrode, and an area of an orthographic projection, on the base substrate, of the light-reflective material layer is positively correlated to an area of the orthographic projection, on the base substrate, of the pixel electrode.

Optionally, the thin film transistor and the pixel electrode in each pixel unit are sequentially laminated in a direction going away from the base substrate; and
the display substrate further includes a dielectric layer disposed between the thin film transistor and the pixel electrode;
wherein an overlap region is present between the orthographic projection, on the base substrate, of the gate electrode of the thin film transistor and the orthographic projection, on the base substrate, of the pixel electrode, and an orthographic projection, on the base substrate, of the dielectric layer is overlapped with the overlap region.

Optionally, a dielectric constant of the dielectric layer is less than a dielectric constant threshold, and a thickness of the dielectric layer is greater than a thickness threshold.

Optionally, the dielectric layer is made of an organic resin.

Optionally, the orthographic projection, on the base substrate, of the dielectric layer covers the orthographic projection, on the base substrate, of the gate electrode of the thin film transistor.

Optionally, the dielectric layer is made of a metal.

Optionally, the thin film transistor further includes an active layer; wherein the orthographic projection, on the base substrate, of the dielectric layer is not overlapped with an orthographic projection, on the base substrate, of the active layer.

In another aspect, a method for driving a display substrate is provided. The display substrate is the display substrate as described above. The method includes:
sequentially providing, in a scanning direction of a plurality of gate lines on the display substrate, a gate driving signal to each of the gate lines, and providing data signals to a plurality of data lines on the display substrate;
wherein when the gate driving signal is provided to the n^{th} gate line, the thin film transistors in the pixel units in the n^{th} row charge the pixel electrodes in the pixel units in the n^{th} row to a first potential in response to the gate driving signal and the data signal; when the gate driving signal is provided to the n^{th} gate line, under a coupling effect of a parasitic capacitor formed by the gate electrodes of the thin film transistors in the pixel units in the n^{th} row and the n^{th} gate lines and the pixel electrodes in the pixel units in the (n+1)^{th} row, potentials of the pixel electrodes in the pixel units in the (n+1)^{th} row are pulled to a second potential; and the second potential is lower than the first potential.

In still another aspect, a method for repairing a display substrate is provided, wherein the display substrate is the display substrate as described above. The method includes:
determining first target pixel units with a dead pixel; and
connecting the pixel electrodes in the first target pixel units to gate lines connected to second target pixel units;
wherein the first target pixel units are disposed in one of the n^{th} row and the (n+1)^{th} row, and the second target pixel units are disposed in the other row of the n^{th} row and the (n+1)^{th} row, n being an integer greater than or equal to 1.

In still another aspect, a display panel is provided. The display panel includes: an alignment substrate, and the display substrate as described above.

Optionally, the display panel further includes: a driving circuit; and
wherein the driving circuit is connected to a plurality of gate lines and a plurality of data lines on the display substrate; and the driving circuit is configured to provide gate driving signals to the plurality of gate lines, and to provide data signals to the plurality of data lines.

Optionally, the display panel is a total reflective type liquid crystal display panel, or a semitransparent type liquid crystal display panel.

In yet still another aspect, a display device is provided. The display device includes: the display panel as described above.

### BRIEF DESCRIPTION OF THE DRAWINGS

For clearer descriptions of the technical solutions in the embodiments of the present disclosure, the following briefly introduces the accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIG. 1 is a schematic structural diagram of a display substrate according to an embodiment of the present disclosure;

FIG. 2 is a schematic structural diagram of a pixel unit according to an embodiment of the present disclosure;

FIG. 3 is a charging timing diagram of a pixel electrode in an LCD panel in the related art;

FIG. 4 is a schematic structural diagram of another display substrate according to an embodiment of the present disclosure;

FIG. 5 is a schematic structural diagram of yet another display substrate according to an embodiment of the present disclosure;

FIG. 6 is a schematic structural diagram of still further display substrate according to an embodiment of the present disclosure;

FIG. 7 is a flowchart of a method for driving a display substrate according to an embodiment of the present disclosure;

FIG. 8 is a charging timing diagram of a pixel electrode according to an embodiment of the present disclosure;

FIG. 9 is a flowchart of a method for repairing a display substrate according to an embodiment of the present disclosure;

FIG. 10 is a schematic structural diagram of a display panel according to an embodiment of the present disclosure;

FIG. 11 is a schematic structural diagram of another display panel according to an embodiment of the present disclosure;

FIG. 12 is a schematic diagram of an actually-measured value of a Vcom according to an embodiment of the present disclosure; and

FIG. 13 is a schematic diagram of an actually-measured value of a flicker degree according to an embodiment of the present disclosure.

### DETAILED DESCRIPTION

For clearer descriptions of the objectives, technical solutions, and advantages of the present disclosure, an inventive concept of the embodiments of the present disclosure is described in detail below in combination with the accompanying drawings and some embodiments.

LCD panels generally include: transmissive LCD panels and reflective type liquid crystal display (RLCD) panels. Moreover, the RLCD panels may further include total reflective type LCD panels and semitransparent LCD panels. The transmissive LCD panel refers to a panel that achieves display by adopting light emitted from a backlight source, and the RLCD panel refers to a panel that achieves display by using reflection of ambient light. The LCD panel described in the embodiments of the present disclosure may be any type of LCD panel, and the following embodiments take the RLCD panel as an example to illustrate the content of the present disclosure.

In the related art, in each pixel unit of the transmissive LCD panel, a pixel electrode generally does not cover an entire thin film transistor, and may only cover one electrode (for example, a source electrode) of the source/drain electrode of the thin film transistor connected to the pixel electrode. Correspondingly, in each pixel unit, a gate electrode of the thin film transistor does not form a parasitic capacitor with the pixel electrode. In the process of research, the inventors found that for the RLCD panel that multiplexes the pixel electrode as a light-reflecting layer. To increase a reflectivity, the pixel electrode with a larger area may generally be set to increase a reflection area. As a result, in each pixel unit, the pixel electrode and the gate electrode of the thin film transistor are overlapped in a direction perpendicular to a display panel. At this time, the parasitic capacitor is formed between the pixel electrode and the gate electrode of the thin film transistor, which may cause a flicker phenomenon when the RLCD panel displays a picture.

The embodiments of the present disclosure provide a display substrate. In the display panel with the display substrate, the problem of picture flicker caused by the parasitic capacitor formed between the pixel electrode in the pixel unit and the gate electrode of the thin film transistor of the pixel unit can he effectively alleviated, and further, the reflectivity of the RLCD panel with the display substrate can be effectively improved.

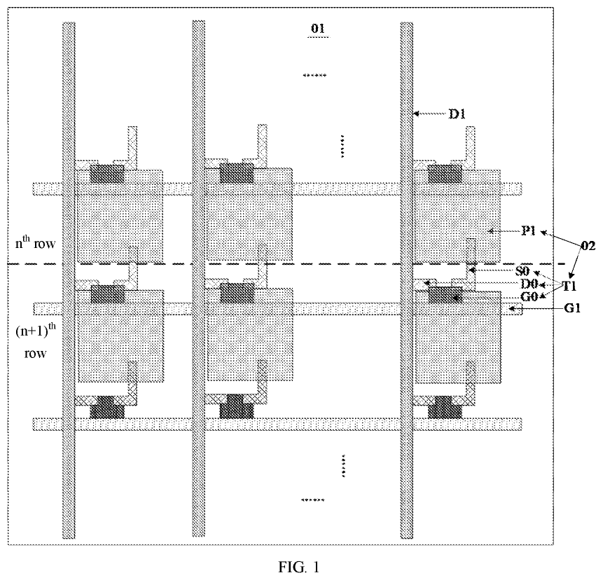

FIG. 1 is a schematic structural diagram of a display substrate according to an embodiment of the present disclosure. As shown in FIG. 1, the display substrate may include: a base substrate 01, a plurality of gate lines G1 and a plurality of data lines D1 which are disposed on the base substrate 01, and a plurality of pixel units 02 which are disposed on the base substrate 01 and are arrayed in rows and columns. Each gate line G1 may extend in a first direction, each data line D1 may extend in a second direction, and the first direction and the second direction may cross each other, for example, may be perpendicular to each other.

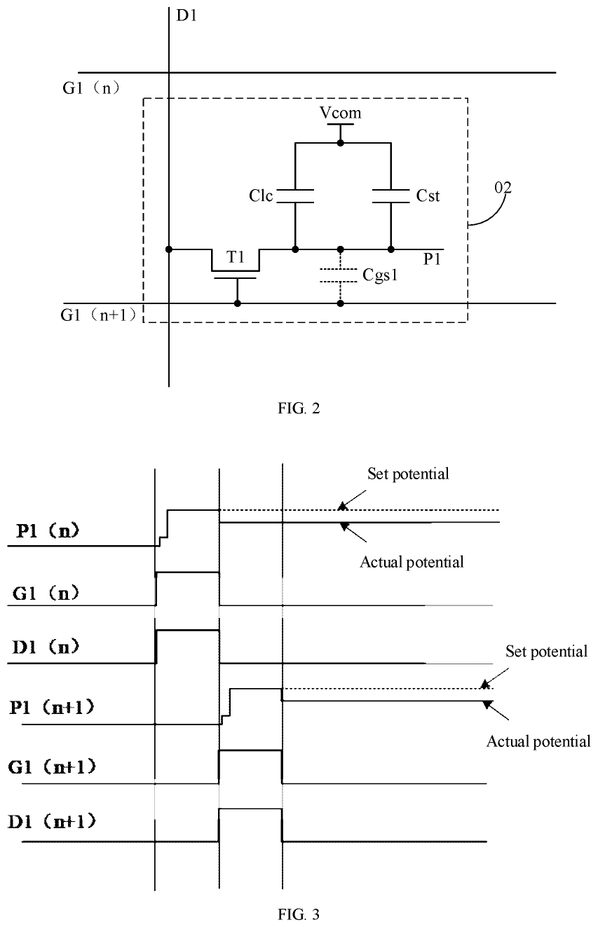

FIG. 2 is a schematic structural diagram of a pixel unit according to an embodiment of the present disclosure. In combination with FIG. 1 and FIG. 2, each pixel unit 02 may include: a thin film transistor T1 and a pixel electrode P1. A gate electrode G0 of the thin film transistor T1 may be connected to one gate line G1, for example, G1(n+1) shown in FIG. 2. A first electrode D0 of the thin film transistor T1 may be connected to one data line D1, and a second electrode S0 of the thin film transistor T1 may be connected to the pixel electrode P1. Optionally, the first electrode of the thin film transistor T1 may be a source electrode or a drain electrode, and the second electrode may be the other electrode of the source electrode and the drain electrode. Referring to FIG. 1 the embodiments of the present disclosure take a case that the first electrode of the thin film transistor T1 is the drain electrode D0 and the second electrode of the thin film transistor T1 is the source electrode S0 as an example for illustration.

Referring to FIG. 2, each pixel unit 02 may further include a common electrode Vcom, and the common electrode Vcom may be disposed on the display substrate, or may also be disposed on an opposite substrate disposed opposite to the display substrate. In a scenario where the common electrode Vcom is disposed on an alignment substrate (for example, a twisted nematic (TN) type liquid crystal display panel), liquid crystal molecules may be included between the common electrode ‘icon’ and the pixel electrode P1, and the common electrode Vcom and the pixel electrode P1 may be equivalent to a capacitor of liquid crystal (C1c). At the same time, a common electrode Vcom2 may also be disposed on the display substrate. A capacitor of storage (Cst) may also be formed between the common electrode Vcom2 and the pixel electrode P1. In response to a gate driving signal provided by the gate line G1 connected to the thin film transistor T1, the thin film transistor T1 may output a data signal from the connected data line D1 to the pixel electrode P1 connected to the thin film transistor T1, so as to charge the pixel electrode P1, such that a potential difference is formed between the pixel electrode P1 and the common electrode Vcom. The liquid crystal molecules may be deflected under an action of the potential difference, and further the pixel unit 02 emits light.

In the related art, an orthographic projection, on the base substrate, of the thin film transistor in each pixel unit is overlapped with an orthographic projection of the pixel electrode on the base substrate, that is, the pixel electrode in each pixel unit may cover the gate electrode of the thin film transistor, and may even cover the gate line connected to the gate electrode. Therefore, for each pixel unit, the parasitic capacitor may be formed between the gate electrode of the thin film transistor in the pixel unit and the gate line connected to the gate electrode, and the pixel electrode in the pixel unit, referring to Cgs1 marked with a dashed line of FIG. 2. When a potential on the gate line G1 changes, due to a coupling effect of Cgs1, a potential of the pixel electrode P1 connected to the gate line G1 is pulled to deviate from the set potential. Since the potential of the pixel electrode P1 changes, but a potential of the common electrode Vcom is generally a fixed value, the potential difference between the pixel electrode and the common electrode will change, which eventually causes abnormal deflection of the liquid crystal molecules and a poor display effect. Besides, in addition to the parasitic capacitor Cgs1, in each pixel unit, another parasitic capacitor Cgs2 is formed between the gate electrode of the thin film transistor and one electrode, that is, the source electrode of the pixel electrode connected to the thin film transistor. The parasitic capacitor Cgs2 is caused by a structural defect of the thin film transistor and cannot be avoided. The parasitic capacitor Cgs1. is caused by an overlap region with the gate electrode of the thin film transistor due to the larger area of the pixel electrode. In particular, the pixel electrode is multiplexed as the light-reflecting layer, and in order to improve the reflectivity, the display substrate in the RLCD panel with the pixel electrode with a larger area is disposed. It may also be caused by disposing the transmissive LCD panel with the pixel electrode with a larger area to increase a capacitance.

For example, FIG. 3 shows a timing schematic diagram of potentials charged to the pixel unit 02 in the n^{th} row and the pixel unit 02 in the (n+1)^{th} row in the related art. Referring to FIG. 3, it can be seen that when the n^{th} gate line G1(n) provides a gate driving signal and the n^{th} data line D1(n) provides a data signal, the potential charged to the pixel electrode P1(n) of the pixel unit 02 in the n^{th} row has jump with a specific degree both in an initial stage of charging and a final stage of charging. In addition, the actual potential finally charged to the pixel electrode P1(n) deviates from the set potential. The same is true for the pixel unit 02 in the (n+1)^{th} row, n being an integer greater than or equal to 1.

Optionally, the potential difference ΔVp between the actual potential and the set potential may meet:

$$Δ Vp = \frac{C 1}{C 1 + C 2 + C 3} ( Vgh - Vgl ) . \qquad Formula ( 1 )$$

C1 refers to a sum of capacitances of the parasitic capacitors Cgs1 and Cgs2, C2 refers to a capacitance of the C1c, C3 refers to a capacitance of the Cst, Vgh refers to an effective potential of the gate driving signal, Vg1 refers to an ineffective potential of the gate driving signal, and C1, C3, Vgh, and Vg1 are generally fixed values. Optionally, the effective potential may be greater than the ineffective potential, or the effective potential may be less than the ineffective potential. It can be seen from the above formula (1) that the larger the capacitance of the parasitic capacitor Cgs1 is, the larger the C1 is, further the larger the ΔVp difference between different gray levels is, and the more serious the picture flicker is.

Referring to FIG. 1, in the embodiments of the present disclosure, in a scanning direction of the plurality of gate lines G1, an orthographic projection of the gate electrode G0 of the thin film transistor T1 in the pixel unit 02 in the n^{th} arrow and an orthographic projection of the connected gate line G1 on the base substrate 01 are spaced apart from an orthographic projection of the pixel electrode P1 in the pixel unit 02 in the n^{th} row on the base substrate 01, and are overlapped with an orthographic projection of the pixel electrode P1 in the pixel unit 02 in the (n+1)^{th} row on the base substrate 01. That is, in the embodiments of the present disclosure, the orthographic projection of the gate electrode G0 of the thin film transistor T1 in the pixel unit 02 in the n^{th} row and the orthographic projection of the connected gate line G1 on the base substrate 01 are only overlapped with the orthographic projection of the pixel electrode P1 in the pixel unit 02 in the (n+1)^{th} row on the base substrate 01, but are not overlapped with the orthographic projection of the pixel electrode P1 in the pixel unit 02 in the n^{th} row on the base substrate 01.

With such an arrangement, a parasitic capacitor (for example, Cgs1 shown in FIG. 2) may not be formed between the gate electrode G0 of the thin film transistor T1 in the pixel unit 02 in the n^{th} row and the connected gate line G1, and the pixel electrode P1 in the pixel unit 02 in the n^{th} row. Although the parasitic capacitor Cgs1 may be formed between the gate electrode G0 of the thin film transistor T1 in the pixel unit 02 in the n^{th} row and the connected gate line G1, and the pixel electrode P1 in the pixel unit 02 in the (n+1)^{th} row, since the pixel units in the n^{th} row and the (n+1)^{th} row are charged sequentially, that is, that is, scanning of the (n+1)^{th} gate line G1(n+1) is not started until scanning of the n^{th} gate line G1(n) is completed, the potential of the n^{th} gate line G1(n) has been stabilized in the case that the pixel unit 02 in the (n+1)^{th} row starts to be charged, and the parasitic capacitor Cgs1 formed between the gate electrode G0 of the thin film transistor T1 in the pixel unit 02 in the n^{th} row and the n^{th} gate line G1 and the pixel electrode P1 in the pixel unit 02 in the (n+1)^{th} row may not affect the potential of the pixel unit 02 in the (n+1)^{th} row that is being charged or has been charged.

In summary, the embodiments of the present disclosure provide a display substrate. In the scanning direction of the gate lines, the orthographic projection, on the base substrate, of the gate electrode of the thin film transistor in the pixel unit in the n^{th} row and the orthographic projection, on the base substrate, of the connected gate line and the orthographic projection, on the base substrate, of the pixel electrode in the pixel unit in the (n+1)^{th} row are overlapped and are spaced apart from the orthographic projection, on the base substrate, of the pixel electrode in the pixel unit in the n^{th} row, that is, are not overlapped with the orthographic projection, on the base substrate, of the pixel electrode in the pixel unit in the n^{th} row. Correspondingly, the parasitic capacitor is formed between the gate electrode of the thin film transistor in the pixel unit in the n^{th} row and the connected gate line and the pixel electrode in the pixel unit in the (n+1)^{th} row, but not formed between the gate electrode of the thin film transistor in the pixel unit in the n^{th} row and the connected gate line and the pixel electrode in the pixel unit in the n^{th} row. Since the driving circuit sequentially charges the pixel units in the n^{th} row and the (n+1)^{th} row, the parasitic capacitor formed between the gate electrode of the thin film transistor in the pixel unit in the n^{th} row and the n^{th} gate line and the pixel electrode in the pixel unit in the (n+1)^{th} row may not affect the pixel unit in the (n+1)^{th} row being charged. The display panel adopting the display substrate has a better display effect.

Optionally, the following embodiments of the present disclosure take the case that the display panel adopting the display substrate is an RLCD panel as an example for illustration. Correspondingly, in order to realize the reflection of light, the display substrate may further include: a light-reflective material layer disposed on a side, distal from the base substrate, of the pixel electrode. In order to improve a reflectivity, an area of an orthographic projection of the light-reflective material layer on the base substrate may be positively correlated to an area of the orthographic projection of the pixel electrode on the base substrate. That is, the larger the area of the pixel electrode is, the larger the area of the light-reflective material layer is; and the smaller the area of the pixel electrode is, the smaller the area of the light-reflective material layer is. Alternatively, the pixel electrode P1 in each pixel unit 02 may be made of a metal, and a reflectivity of the metal may be greater than a reflectivity threshold. That is, the pixel electrode P1 may be multiplexed to realize the reflection of light while realizing conduction.

In addition, when the pixel electrode P1 is used as the light-reflecting layer, a reflection area of the RLCD is positively correlated to the area of the pixel electrode P1. Therefore, in combination with FIG. 1, in the embodiments of the present disclosure, in each pixel unit 02, the orthographic projection, on the base substrate, of the pixel. electrode P1 is set to be overlapped with an orthographic projection, on the base substrate, of the source electrode S0 of the thin film transistor T1, thereby ensuring the larger area of the pixel electrode P1, and improving the reflectivity.

Optionally, in order to further ensure the larger area of the pixel electrode P1, an spacing between the pixel electrodes P1 in any two adjacent pixel units 02 may also be set to be less than an spacing threshold. For example, in combination with FIG. 1, the spacing between the pixel electrodes P1 in any two adjacent pixel units 02 in a direction of the gate line G1 may be within a first spacing range. The spacing between the pixel electrodes P1 in any two adjacent pixel units 02 in a direction of the data line D1 may be within a second spacing range. Moreover, in each pixel unit 02, a vertical distance between the pixel electrode P1 and the data line D1 connected to the thin film transistor T1 may be within a third spacing range.

Optionally, the above spacing range may be flexibly set according to a manufacturing process when the display substrate is manufactured. For example, the first spacing range and the second spacing range generally may be both 3 micrometers (μm) to 7 μm. The third spacing range generally may be 3 μm to 5 μm. That is, for the pixel electrodes P1 in any two adjacent pixel units 02, the spacing in the extending direction of the gate line G1 and the spacing in the extending direction of the data line D1 may be both greater than or equal to 3 μm and less than or equal to 7 μm, and may be, for example, 5 μm. In each pixel unit 02, the vertical distance between the pixel electrode P1 and the data line D1 connected to the thin film transistor T1 may be greater than or equal to 3 μm and less than or equal to 5 μm, and may be, for example, 4 μm.

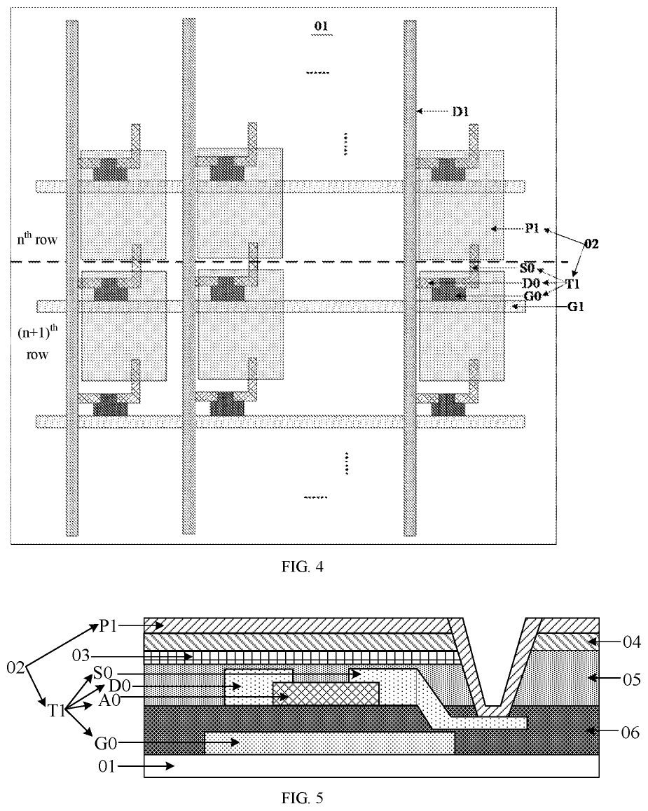

FIG. 4 is a schematic structural diagram of another display substrate according to an embodiment of the present disclosure. As shown in FIG. 4, orthographic projections, on the base substrate 01, of both the first electrode D0 and the second electrode S0 of the thin film transistor T1 in the pixel unit 02 in the n^{th} row may be also overlapped with the orthographic projection, on the base substrate 01, of the pixel electrode PI in the pixel unit 02 in the (n+1)^{th} row. That is, a main body of the thin film transistor T1 in the pixel unit 02 in the n^{th} row may be disposed under the pixel electrode P1 in the pixel unit 02 in the (n+1)^{th} row. That is, referring to FIG. 4, the pixel electrode P1 in the pixel unit 02 in the (n+1)^{th} row may cover the main body of the thin film transistor T1 in the pixel unit 02 in the n^{th} row. In addition, in combination with FIG. 4, the main body of the thin film transistor T1 includes: the entire gate electrode of the thin film transistor T1, most of the first electrode (i.e., the drain electrode) D0, and most of the second electrode (i.e., the source electrode S0).

In combination with FIG. 4, with such an arrangement, it can be further ensured that the gate electrode G0 of the pixel unit 02 in the n^{th} row and the connected gate line G1 are disposed under the pixel electrode P1 in the pixel unit in the (n+1)^{th} row. That is, the gate electrode G0 of the thin film transistor T1 in the pixel unit 02 in the n^{th} row and the connected gate line G1 are further prevented from forming the parasitic capacitor Cgs1 with the pixel electrode P1, thereby effectively improving the display effect. Moreover, the area of the pixel electrode P1 is further increased, and the reflectivity of the RLCD panel that multiplexes the pixel electrode P1 as the light-reflecting layer is improved.

Optionally, since the second electrode S0 of the thin film transistor T1 needs to be connected to the pixel electrode P1, in order to ensure a reliable connection between the two, in combination with FIGS. 1 and 4, the orthographic projection, on the base substrate 01, of the second electrode S0 of the thin film transistor T1 in the pixel unit 02 in the n^{th} row may be also overlapped with the orthographic projection, on the base substrate 01, of the pixel electrode P1 in the pixel unit 02 in the n^{th} row.

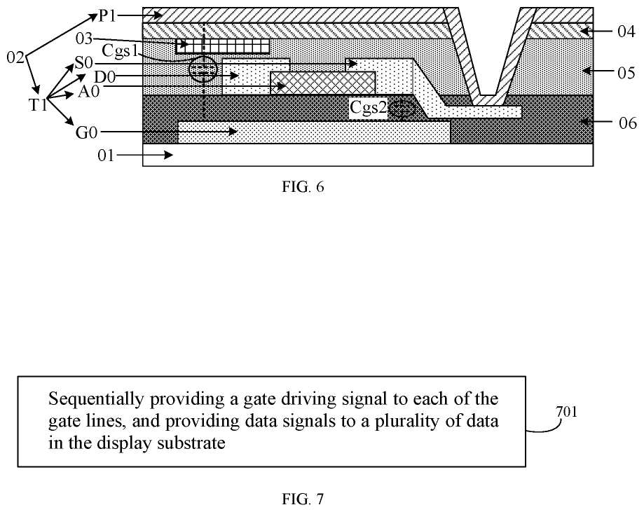

Optionally, FIG. 5 shows a schematic structural diagram of yet another display substrate according to an embodiment of the present disclosure, and FIG. 6 shows a schematic structural diagram of still another display substrate according to an embodiment of the present disclosure. It can be seen in combination with FIG. 5 and FIG. 6 that, in the embodiments of the present disclosure, the thin film transistor T1 and the pixel electrode P1 which are included in each pixel unit 02 may be sequentially laminated in a direction going away from the base substrate 01. Moreover, in combination with FIGS. 4-6, the display substrate may further include: a dielectric layer 03 disposed between the thin film transistor T1 and the pixel electrode P1 which have an overlap region, for example, the dielectric layer 03 disposed between the thin film transistor T1 in the pixel unit 02 in the n^{th} row and the pixel electrode P1 in the pixel unit 02 in the (n+1)^{th} row. Moreover, an orthographic projection, on the base substrate 01, of the dielectric layer 03 may be overlapped with the overlap region. The dielectric layer 03 may be configured to reduce a capacitor value of the parasitic capacitor formed by the gate electrode of the thin film transistor T1 in the pixel unit 02 in the n^{th} row and the connected gate line and the pixel electrode P1 in the pixel unit 02 in the (n+1)^{th} row. Alternatively, the parasitic capacitor formed between the gate electrode of the thin film transistor T1 in the pixel unit 02 in the n^{th} row and the connected gate line and the pixel electrode P1 in the pixel unit 02 in the (n+1)^{th} row is directly shielded, thereby further improving the display effect.

As an optional implementation: the dielectric layer 03 shown in FIG. 5 may be made of a non-metal material. In the case that the dielectric layer 03 is made of the non-metal material, in order to effectively reduce the capacitance of the parasitic capacitor formed by the gate electrode of the thin film transistor T1 in the pixel unit 02 in the n^{th} row and the connected gate line and the pixel electrode P1 in the pixel unit 02 in the (n+1)^{th} row, a dielectric constant of the dielectric layer 03 may be less than a dielectric constant threshold, and a thickness of the dielectric layer 03 may be greater than a thickness threshold. Still referring to FIG. 5, the orthographic projection, on the base substrate 01, of the dielectric layer 03 may cover the orthographic projection, on the base substrate 01, of the gate electrode G0 of the thin film transistor T1. For example, the dielectric layer 03 may be made of an organic resin. Assuming that the dielectric layer 03 is disposed between the thin film transistor T1 in the pixel unit 02 in the n^{th} row and the pixel electrode P1 in the pixel unit 02 in the (n+1)^{th} row, then the orthographic projection, on the base substrate 01, of the dielectric layer 03 may cover the orthographic projection, on the base substrate 01, of the gate electrode G0 of the thin film transistor T1, which means that the orthographic projection, on the base substrate 01, of the dielectric layer 03 covers the gate electrode G0 of the thin film transistor T1 in the pixel unit 02 in the n^{th} row.

As another optional implementation: the dielectric layer 03 shown in FIG. 6 may be made of a metal. The dielectric layer 03 made of the metal may realize direct shielding for the parasitic capacitor formed by the gate electrode of the thin film transistor T1 in the pixel unit 02 in the n^{th} row and the connected gate line and the pixel electrode P1 in the pixel unit 02 in the (n+1)^{th} row.

In combination with FIGS. 5 and 6, the thin film transistor T1 may include an active layer A0 in addition to the gate electrode G0, the source/drain (S0 and D0) electrode. The active layer A0 may be disposed between the source/drain (S0 and D0) electrode and the gate electrode G0, and the source/drain (S0 and D0) electrode may partially cover the active layer A0.

It should be noted that when the dielectric layer 03 is made of the metal, in order to avoid an influence of the metal on the movement of carriers between channels of the source/drain, referring to FIG. 6, the orthographic projection of the dielectric layer 03, on the base substrate 01, made of the metal may be not overlapped with an orthographic projection, on the base substrate 01, of the active layer A0. Assuming that the dielectric layer 03 is disposed between the thin film transistor T1 in the pixel unit 02 in the n^{th} row and the pixel electrode P1 in the pixel unit 02 in the (n+1)^{th} row, no overlap herein means that the dielectric layer 03 is not overlapped with the orthographic projection, on the base substrate 01. of the active layer A0 of the thin film transistor T1 in the pixel unit in the n^{th} row. In order to further avoid the influence of the metal on the movement of the carriers between the channels of the source and drain, the dielectric layer 03 also needs to be not overlapped with the orthographic projection, on the base substrate 01, of the active layer A0 of the thin film transistor T1 in the pixel unit 02 in other rows (for example, the (n+1)^{th} row).

Optionally, in order to further effectively avoid the influence on the display effect caused by the parasitic capacitor formed by the gate electrode of the thin film transistor T1 in the pixel unit 02 in the n^{th} row and the connected gate line and the pixel electrode P1 in the pixel unit 02 in the (n+1)^{th} row, a plurality of dielectric layers 03 may he disposed. For example, one dielectric layer 03 made of the organic resin may he disposed, and one dielectric layer 03 made of the metal may be disposed.

Optionally, in combination with FIGS. 5 and 6, the display substrate may further include insulating layers (for example, 04, 05, and 06 shown in the drawings) disposed between every two adjacent layers of structures. Moreover, FIG. 6 also shows the formed parasitic capacitors Cgs1 and Cgs2. Assuming that the dielectric layer 03 shown in FIGS. 5 and 6 is disposed between the thin film transistor T1 in the pixel unit 02 in the n^{th} row and the pixel electrode P1 in the pixel unit 02 in the (n+1)^{th} row, Cgs1 here refers to the parasitic capacitor formed by the gate electrode of the thin film transistor T1 in the pixel unit 02 in the n^{th} row and the connected gate line and the pixel electrode P1 in the pixel unit 02 in the (n+1)^{th} row, and Cgs2 refers to the parasitic capacitor formed by the second electrode S0 and the gate electrode G0 of the thin film transistor T1 in the pixel unit 02 in the n^{th} row.

Optionally, assuming that, like the related art, the orthographic projections, on the base substrate, of the gate electrode of the thin film transistor in the pixel unit in the n^{th} row and the connected gate line are overlapped with the orthographic projection, on the base substrate, of the pixel electrode in the pixel unit in the n^{th} row, then as an alternative solution to the above embodiments, the dielectric layer 03 may be directly disposed between the thin film transistor in the pixel unit in the n^{th} row and the pixel electrode in the pixel unit in the n^{th} row which the overlap region is present. That is, by adding the dielectric layer 03, the capacitance of the parasitic capacitor Cgs1 formed between the gate electrode of the thin film transistor in the pixel unit in the n^{th} row and the connected gate line, and the pixel electrode in the pixel unit in the n^{th} row is reduced, or the parasitic capacitor Cgs1 is directly shielded. An optional position and an optional material of the dielectric layer 03 may refer to the description of the embodiments of FIGS. 5 and 6, which may not be repeated here.

Optionally, the display substrate may include an active area (AA) and a non-active area, and the pixel unit 02 described in the above embodiments may be disposed in the AA. The non-active area may be configured to dispose a driving circuit for providing signals to the gate lines and the data lines. In addition, the thin film transistor T1 described in the embodiments of the present disclosure may be made of an a-silicon (a-Si) material, a low temperature poly silicon (LTPS) material, or an oxide material.

In summary, the embodiments of the present disclosure provide a display substrate. In the scanning direction of the gate lines, the orthographic projection, on the base substrate, of the gate electrode of the thin film transistor in the pixel unit in the n^{th} row, the orthographic projection, on the base substrate, of the connected gate line, and the orthographic projection, on the base substrate, of the pixel electrode in the pixel unit in the (n+1)^{th} row are overlapped and are spaced apart from the orthographic projection, on the base substrate, of the pixel electrode in the pixel unit in the n^{th} row, that is, are not overlapped with the orthographic projection, on the base substrate, of the pixel electrode in the pixel unit in the n^{th} row. Correspondingly, the parasitic capacitor is formed between the gate electrode of the thin film transistor in the pixel unit in the n^{th} row and the connected gate line and the pixel electrode in the pixel unit in the (n+1)^{th} row, but not formed between the gate electrode of the thin film transistor in the pixel unit in the n^{th} row and the connected gate line and the pixel electrode in the pixel unit in the n^{th} row. Since the driving circuit sequentially charges the pixel units in the n^{th} row and the (n+1)^{th} row, the parasitic capacitor formed between the gate electrode of the thin film transistor in the pixel unit in the n^{th} row and the n^{th} gate line and the pixel electrode in the pixel unit in the (n+1)^{th} row may not affect the pixel unit in the (n+1)^{th} row being charged. The display panel adopting the display substrate achieves a better display effect.

FIG. 7 is a flowchart of a method for driving a display substrate according to an embodiment of the present disclosure. The display substrate may be the display substrate as shown in any one of FIG. 1 and FIGS. 4 to 6. As shown in FIG. 7. the method may include the following processes.

In 701, a gate driving signal is sequentially provided to each of the gate lines, and data signals are provided to a plurality of data lines in the display substrate.

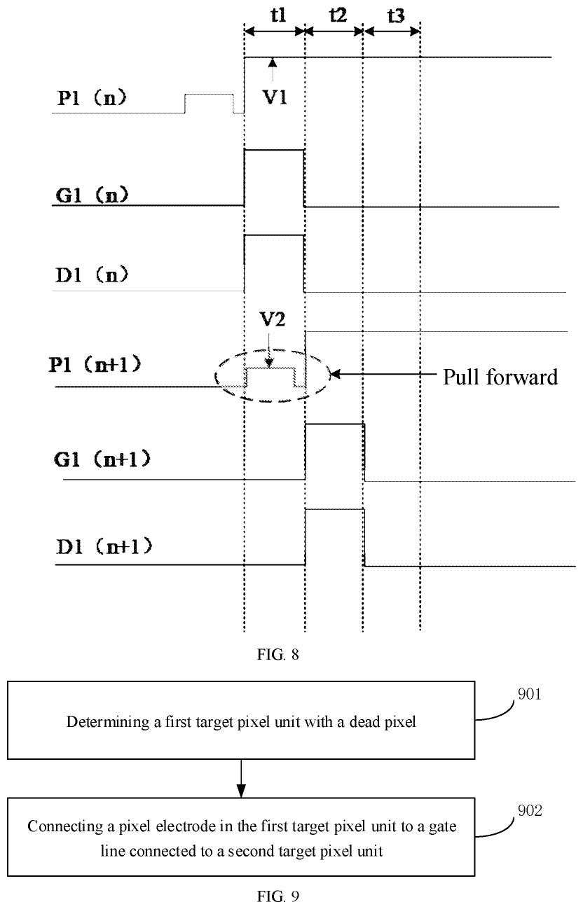

Orthographic projections, on a base substrate, of a gate electrode of a thin film transistor in a pixel unit in the n^{th} row and a connected gate line are overlapped with an orthographic projection, on the base substrate, of a pixel electrode in the pixel unit in the (n+1)^{th} row. Therefore, in combination with FIG. 8, when the gate driving signal is provided to the n^{th} gate line G1(n), the thin film transistor T1 in the pixel unit 02 in the n^{th} row may charge a pixel electrode P1(n) in the pixel unit 02 in the n^{th} row to a first potential V1 in response to the gate driving signal and the data signal. In the same phase, under a coupling effect of the parasitic capacitor Cgs1 formed by the gate electrode of the thin film transistor T1 of the pixel unit 02 in the n^{th} row and the n^{th} gate line, and a pixel electrode P1 (n+1) in the pixel unit 02 in the (n+1)^{th} row, the pixel electrode P1(n+1) in the pixel unit 02 in the (n+1)^{th} row is pulled to a second potential V2, and the second potential V2 may be less than the first potential V1.

That is, by comparing FIG. 3 and FIG. 8, in the embodiments of the present disclosure, the influence of the parasitic capacitor Cgs1 on the potential of the pixel electrode P1 in the pixel unit 02 in the corresponding row is adjusted to a state before the pixel unit 02 in the corresponding row is charged. That is, referring to FIG. 8, the moment of a potential jump of the pixel electrode P1 caused by the parasitic capacitor Cgs1 is forwarded, thereby effectively avoiding the influence on normal charging of the pixel unit 02 being charged, and improving the display effect.

In combination with FIG. 8, a charging process for the pixel unit in the n^{th} row and the pixel unit in the (n+1)^{th} row may he divided into three stages: referring to FIG. 8, in a first phase t1, the gate driving signal is provided to the n^{th} gate line G1(n). At this time, only the thin film transistors T1 in the pixel units 02 in the n^{th} row are turned on, and the plurality of data lines D1 write the first potential to the pixel electrodes P1(n) in the pixel units 02 in the n^{th} row through the turned-on thin film transistors T1. Moreover, in the first phase t1, since the orthographic projections, on the base substrate 01, of the gate electrode G0 of the thin film transistor T1 of the pixel unit 02 in the n^{th} row and the connected gate line G1(n) are overlapped with the orthographic projection, on the base substrate 01, of the pixel electrode P1 in the pixel unit 02 in the (n+1)^{th} row, the parasitic capacitor Cgs1 is formed. Under the coupling effect of the parasitic capacitor Cgs1, the n^{th} gate line G1(n) causes a pull on the potential of the pixel electrode P1(n+1) in the pixel unit 02 in the (n+1)^{th} row. Referring to FIG. 8, the potential of the pixel electrode P1(n+1) in the pixel unit 02 in the (n+1)^{th} row is pulled to the second potential, which deviates from the initial potential.

In a second phase t2, the gate driving signal is stopped from being provided to the n^{th} gate line G1(n), and the gate driving signal starts to be provided to the (n+1)^{th} gate line G1(n+1). At this time, only the thin film transistors T1 in the pixel units 02 in the (n+1)^{th} row are turned on, and the plurality of data lines D1 write the first potential to the pixel electrodes P1(n+1) in the pixel units 02 in the (n+1)^{th} row through the turned-on thin film transistors T1. Besides, in the second phase t2, the parasitic capacitor Cgs1 formed between the gate electrode G0 of the thin film transistor T1 of the pixel unit 02 in the n^{th} row and the n^{th} gate line G1(n) and the pixel electrode P1(n+1) in the pixel unit 02 in the (n+1)^{th} row may not exert any influence on the potential of the pixel electrode P1(n+1).

In a third phase t3, the pixel unit 02 in the (n+1)^{th} row is fully charged and reaches a set potential. At this time, the potential of the pixel electrode P1(n+1) in the pixel unit 02 in the (n+1)^{th} row is only affected by the parasitic capacitor Cgs2, and a changing magnitude is small. Furthermore, the flicker phenomenon of a display picture is significantly improved.

It should be noted that providing the gate driving signal to the gate line means providing the gate driving signal of an effective potential to the gate line, and stopping providing the gate driving signal to the gate line means providing the gate driving signal of an ineffective potential to the gate line. The effective potential may be a high potential, and correspondingly, the ineffective potential may he a low potential. Alternatively, the effective potential may be a low potential, and the ineffective potential may be a high potential. The effective potential and the ineffective potential depend on a type of the thin film transistor T1. For example, in the case that the thin film transistor T1 is an N type transistor, the effective potential may be the high potential and the ineffective potential may be the low potential. In the case that the thin film transistor T1 is a P type transistor, the effective potential may be the low potential and the ineffective potential may be the high potential.

In summary, the embodiments of the present disclosure provide a method for driving a display substrate. When the gate driving signal is provided to the n^{th} gate line, the thin film transistor in the pixel unit in the row can charge the pixel electrode in the pixel unit in the n^{th} row to the first potential in response to the gate driving signal and the data signal. Under the coupling effect of the parasitic capacitor formed between the gate electrode of the thin film transistor of the pixel unit in the n^{th} row and the n^{th} gate line, and the pixel electrode in the pixel unit in the (n+1)^{th} row, the potential of the pixel electrode in the pixel unit in the (n+1)^{th} row is pulled to the second potential less than the first potential. Since the pixel units in the n^{th} row and the (n+1)^{th} row are sequentially charged, the parasitic capacitor formed between the gate electrode of the thin film transistor in the pixel unit in the n^{th} row and the n^{th} gate line and the pixel electrode in the pixel unit in the (n+1)^{th} row may not affect the pixel unit being charged. The display panel adopting the display substrate according to the embodiments of the present disclosure has a better display effect.

Optionally, FIG. 9 is a flowchart of a method for repairing a display substrate according to an embodiment of the present disclosure. The display substrate may he the display substrate as shown in any one of FIG. 1 and FIGS. 4 to 6. As shown in FIG. 9, the method may include:

In 901, a first target pixel unit with a dead pixel is determined.

Optionally, a number of different reasons for the dead pixel of the pixel unit may be present, for example, a data line connected to the pixel unit is short-circuited (open). In the embodiments of the present disclosure, various test methods (for example, array test) may be adopted to determine the first target pixel unit with the dead pixel. Moreover, by taking the case that the display substrate is a twisted nematic (TN) type display substrate, and normal display of the display panel with the TN type display substrate is a normally white state as an example, the dead pixel determined in 901 may be a bright spot.

In 902, the pixel electrode in the first target pixel unit is connected to a gate line connected to a second target pixel unit.

Optionally, the pixel electrode in the first target pixel unit may be connected to the gate line connected to the second target pixel unit by means of laser welding. In combination with FIG. 1, the first target pixel unit may be disposed in one of the n^{th} and (n+1)^{th} rows, and the second target pixel unit may be disposed in the other row of the n^{th} and (n+1)^{th} rows, n being an integer greater than or equal to 1. That is, in the case that the first target pixel unit is a pixel unit in the pixel units in the n^{th} row, the second target pixel unit is a pixel unit in the pixel units in the (n+1)^{th} row. In the case that the first target pixel unit is a pixel unit in the pixel units in the (n+1)^{th} row, the second target pixel unit is a pixel unit in the pixel units in the n^{th} row.

In the embodiments of the present disclosure, orthographic projections, on a base substrate, of a gate electrode of a thin film transistor in the pixel unit in the n^{th} row and a connected gate line are overlapped with the orthographic projection, on the base substrate, of a pixel electrode in the pixel unit in the (n+1)^{th} row. Therefore, assuming that the first target pixel unit is a pixel unit in the pixel units in the (n+1)^{th} row, the second target pixel unit is a pixel unit in the pixel units in the n^{th} row, and the dead pixel is a bright spot, then when it is detected that the first target pixel unit has the bright spot, the pixel electrode in the lighted pixel unit in the pixel units in the (n+1)^{th} row may be connected to the gate line G1 connected to the pixel units in the n^{th} row. After being connected, a larger voltage difference may be present between the pixel electrode of the lighted first target pixel unit and a common electrode, and then the lighted first target pixel unit is dimmed to achieve an effect of repairing the bright spot.

In summary, the embodiments of the present disclosure provide a method for repairing a display substrate. Since the thin film transistor in the pixel unit in the nth row and the pixel electrode in the pixel unit in the (n+1)^{th} row in the display substrate are disposed in unique positions, when the first target pixel unit with a dead pixel is determined, the pixel electrode in the first target pixel unit is directly connected to the gate line connected to the second target pixel unit to achieve the purpose of repairing the dead pixel, and the repairing method is relatively simple.

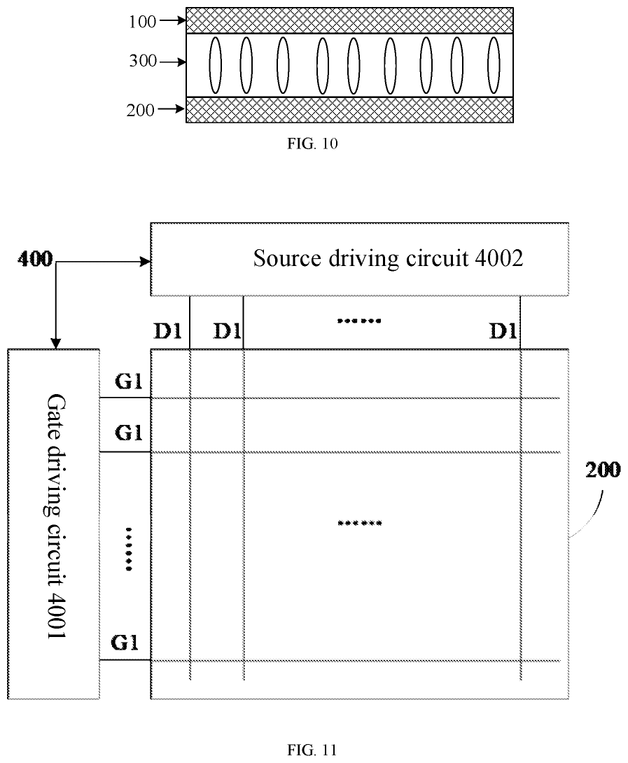

Optionally, FIG. 10 is a schematic structural diagram of a display panel according to an embodiment of the present disclosure. As shown in FIG. 10, the display panel may include: an alignment substrate 100 and a display substrate 200 as shown in any one of FIG. 1 and FIGS. 4-6.

Optionally, the alignment substrate 100 may be a color filter substrate, and the display substrate 200 may be an array substrate. Correspondingly, referring to FIG. 10, the display panel may further include: a liquid crystal layer 300 disposed between the alignment substrate 100 and the display substrate 200, and the liquid crystal layer 300 includes a plurality of liquid crystal molecules. That is, the display panel may be an LCD panel.

Optionally, FIG. 11 is a schematic structural diagram of another display panel according to an embodiment of the present disclosure. As shown in FIG. 11, the display panel may further include a driving circuit 400.

The driving circuit 400 may be respectively connected to a plurality of gate lines G1 and a plurality of data lines D1 in the display substrate 200, and the driving circuit 400 may be configured to provide gate driving signals to the plurality of gate lines G1 and to provide data signals to the plurality of data lines D1.

For example, referring to FIG. 11, the driving circuit 400 may include agate driving circuit 4001 and a source driving circuit 4002. The gate driving circuit 4001 may be connected to the plurality of gate lines G1 for providing the gate driving signals to the plurality of gate lines G1. The source driving circuit 4002 may be connected to the plurality of data lines D1 for providing the data signals to the plurality of data lines D1.

Optionally, the RLCD panel may be a total reflective RLCD panel, or may be a semitransparent RLCD panel.

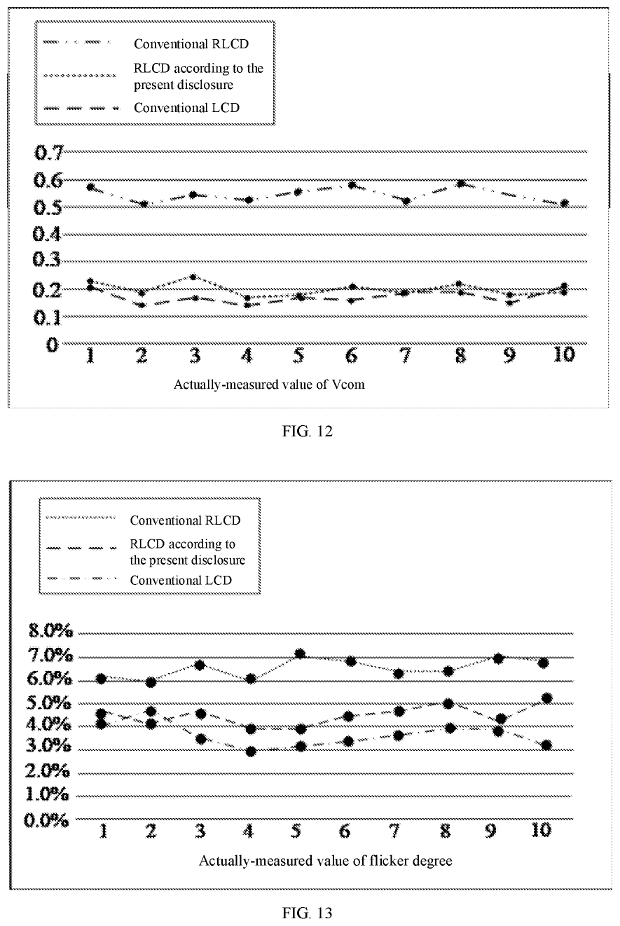

By taking the picture with a gray scale of 127 as an example, conventional LCDs, conventional RLCDs in the related art are compared with the RLCD according to the embodiments of the present disclosure. FIGS. 12 and 13 show an actually-measured value of a potential of a common electrode Vcom and an actually-measured value of a flicker degree of each sample due to a parasitic capacitor in ten randomly selected samples (that is, the pixel units), at the moment when the thin film transistor T1 is turned off.

Optionally, for the conventional LCDs, the parasitic capacitor includes Cgs2 and Cdp (that is, the parasitic capacitor formed between the data line DI and the pixel electrode P1). For the conventional RLCDs, the parasitic capacitor includes Cgs1, Cgs2 and Cdp. For the RLCD according to the present disclosure, the parasitic capacitors include Cgs1, Cgs2, and Cdp. Referring to FIG, 12, it can be seen that the actually-measured value of the V corn of the RLCD according to the present disclosure has dropped from about 0.55 to about 0.2 relative to the conventional RLCDs. Since an ideal potential of the Vcom is 0 in a positive polarity and negative polarity driving switching phase, the less the actually-measured value of the Vcom is, the better display effect is. Therefore, the RLCD according to the embodiments of the present disclosure has a better display effect. Moreover, it can also be seen in combination with FIG. 13 that the flicker degree of the RLCD according to the present disclosure is reduced from about 6% to about 4% compared with the conventional RLCDs, and the flicker degree is significantly reduced.

Optionally, an embodiment of the present disclosure further provides a display device. The display device may include the display panel shown in FIG. 10 or FIG. 11. Optionally, the display device may be any product or assembly with a display function, such as electronic paper, a mobile phone, a tablet computer, a television, a monitor, a laptop, and a navigator.

Described above are merely exemplary embodiments of the present disclosure and are not intended to limit the present disclosure. Within the spirit and principles of the disclosure, any modifications, equivalent substitutions, improvements, and the like are within the protection scope of the present disclosure.

What is claimed is:

1. A display substrate, comprising:
a base substrate;
a plurality of gate lines arrayed in row direction and a plurality of data lines arrayed in column direction on the base substrate; and
a plurality of pixel units disposed on the base substrate and arrayed in row direction and in column direction, wherein each of the pixel units comprises a thin film transistor and a pixel electrode, a gate electrode of the thin film transistor being connected to one of the gate lines, a source electrode of the thin film transistor being connected to the one of the data lines, and a drain electrode of the thin film transistor being connected to the pixel electrode;
wherein orthographic projections, on the base substrate, of the gate electrodes and the gate lines connected to the gate electrodes of the thin film transistors in the pixel units in an n^{th} row are spaced apart from orthographic projections, on the base substrate, of the pixel electrodes in the pixel units in the n^{th} row, and
orthographic projections, on the base substrate, of the gate electrodes and the gate lines connected to the gate electrodes of the thin film transistors in the pixel units in an n^{th} row are partly overlapped with the orthographic projections, on the base substrate, of the pixel electrodes in the pixel units in an (n+1)^{th} row, n being an integer greater than or equal to 1.

2. The display substrate according to claim 1, wherein orthographic projections, on the base substrate, of the source electrode and the drain electrode of the thin film transistor in the pixel unit in the n^{th} row are partly overlapped with the orthographic projection, on the base substrate, of the pixel electrode in the pixel unit in the (n+1)^{th} row.

3. The display substrate according to claim 1, wherein an orthographic projection, on the base substrate, of the drain electrode of the thin film transistor in the pixel unit in the n^{th} row is further partly overlapped with an orthographic projection, on the base substrate, of the pixel electrode in the pixel unit in the n^{th} row.

4. The display substrate according to claim 1, wherein
a spacing between the pixel electrodes in any two adjacent pixel units in a direction of the gate lines is within a first spacing range; and
a spacing between the pixel electrodes in any two adjacent pixel units in a direction of the data lines is within a second spacing range; and
a vertical distance between the pixel electrode and the data line connected to the thin film transistor in each of the pixel units is within a third spacing range.

5. The display substrate according to claim 4, wherein the first spacing range and the second spacing range are both 3 micrometers to 7 micrometers; and the third spacing range is 3 micrometers to 5 micrometers.

6. The display substrate according to claim 1, wherein
the pixel electrode in each pixel unit is made of a metal, a reflectivity of the metal material being greater than a reflectivity threshold; or
the display substrate further comprises a light-reflective material layer disposed on a side, distal from the base substrate, of the pixel electrode, and an area of an orthographic projection, on the base substrate, of the light-reflective material layer is positively correlated to an area of the orthographic projection, on the base substrate, of the pixel electrode.

7. The display substrate according to claim 1, wherein the thin film transistor and the pixel electrode in each pixel unit are sequentially laminated in a direction going away from the base substrate; and
the display substrate further comprises a dielectric layer disposed between the thin film transistor and the pixel electrode;
wherein an overlap region is present between the orthographic projection, on the base substrate, of the gate electrode of the thin film transistor and the orthographic projection, on the base substrate, of the pixel electrode, and an orthographic projection, on the base substrate, of the dielectric layer is overlapped with the overlap region.

8. The display substrate according to claim 7, wherein a dielectric constant of the dielectric layer is less than a dielectric constant threshold, and a thickness of the dielectric layer is greater than a thickness threshold.

9. The display substrate according to claim 8, wherein the dielectric layer is made of an organic resin.

10. The display substrate according to claim 8, wherein the orthographic projection, on the base substrate, of the dielectric layer covers the orthographic projection, on the base substrate, of the gate electrode of the thin film transistor.

11. The display substrate according to claim 7, wherein the dielectric layer is made of a metal.

12. The display substrate according to claim 11, wherein the thin film transistor further comprises an active layer; wherein the orthographic projection, on the base substrate, of the dielectric layer is not overlapped with an orthographic projection, on the base substrate, of the active layer.

13. The display substrate according to claim 8, wherein the orthographic projection, on the base substrate, of the dielectric layer covers the orthographic projection, on the base substrate, of the gate electrode of the thin film transistor;
the spacing between the pixel electrodes in any two adjacent pixel units in the extending direction of the gate line is within the first spacing range; the spacing between the pixel electrodes in any two adjacent pixel units in the extending direction of the data line is within the second spacing range; in each of the pixel units, the vertical distance between the pixel electrode and the data line connected to the thin film transistor is within the third spacing range; the first spacing range and the second spacing range are both 3 micrometers to 7 micrometers; the third spacing range is 3 micrometers to 5 micrometers;
the pixel electrode in each pixel unit is made of a metal, the reflectivity of the metal material being greater than the reflectivity threshold; or, the display substrate further comprises the light-reflective material layer disposed on a side, distal from the base substrate, of the pixel electrode, and the area of the orthographic projection, on the base substrate, of the light-reflective material layer is positively correlated to the area of the orthographic projection, on the base substrate, of the pixel electrode.

14. The display substrate according to claim 11, wherein the thin film transistor further comprises the active layer; the orthographic projection, on the base substrate, of the dielectric layer is not overlapped with the orthographic projection, on the base substrate, of the active layer;
the spacing between the pixel electrodes in any two adjacent pixel units in the extending direction of the gate line is within the first spacing range; the spacing between the pixel electrodes in any two adjacent pixel units in the extending direction of the data line is within the second spacing range; the vertical distance between the pixel electrode and the data line connected to the thin film transistor in each of the pixel units is within the third spacing range; the first spacing range and the second spacing range are both 3 micrometers to 7 micrometers; the third spacing range is 3 micrometers to 5 micrometers; the pixel electrode in each pixel unit is made of a metal, the reflectivity of the metal material being greater than the reflectivity threshold; or, the display substrate further comprises the light-reflective material layer disposed on a side, distal from the base substrate, of the pixel electrode, and the area of the orthographic projection, on the base substrate, of the light-reflective material layer is positively correlated to the area of the orthographic projection, on the base substrate, of the pixel electrode.

15. A method for driving the display substrate according to claim, wherein the method comprises:
sequentially providing a gate driving signal to each of the gate lines, and providing data signals to a plurality of the data lines on the display substrate;
wherein when the gate driving signal is provided to the n^{th} gate line, the thin film transistor in the pixel unit in the n^{th} row charges the pixel electrode in the pixel unit in the n^{th} row to a first potential in response to the gate driving signal and the data signal; when the gate driving signal is provided to the n^{th} gate line, under a coupling effect of a parasitic capacitor formed by the gate electrode of the thin film transistor in the pixel unit in the n^{th} row and the n^{th} gate line and the pixel electrode in the pixel unit in the (n+1)^{th} row, potential of the pixel electrode in the pixel unit in the (n+1)^{th} row is pulled to a second potential; and the second potential is lower than the first potential.

16. A method for repairing the display substrate according to claim 1, wherein the method comprises:
determining a first target pixel unit with a dead pixel; and
connecting a pixel electrode in the first target pixel unit to the gate line connected to a second target pixel unit;
wherein the first target pixel unit is disposed in one of the n^{th} row and the (n+1)^{th} row, and the second target pixel unit is disposed in the other row of the n^{th} row and the (n+1)^{th} row, n being an integer greater than or equal to 1.

17. A display panel, comprising an alignment substrate and a display substrate, wherein the display substrate comprises:
a base substrate;
a plurality of gate lines arrayed in row direction and a plurality of data lines arrayed in column direction on the base substrate; and
a plurality of pixel units disposed on the base substrate and arrayed in row direction and in column direction, wherein each of the pixel units comprises a thin film transistor and a pixel electrode, a gate electrode of the thin film transistor being connected to one of the gate lines, a source electrode of the thin film transistor being connected to the one of the data lines, and a drain electrode of the thin film transistor being connected to the pixel electrode;
wherein orthographic projections, on the base substrate, of the gate electrodes and the gate lines connected to the gate electrodes of the thin film transistors in the pixel units in an n^{th} row are spaced apart from orthographic projections, on the base substrate, of the pixel electrodes in the pixel units in the n^{th} row, and orthographic projections, on the base substrate, of the gate electrodes and the gate lines connected to the gate electrodes of the thin film transistors in the pixel units in an n^{th} row are partly overlapped with the orthographic projections, on the base substrate, of the pixel electrodes in the pixel units in an (n+1)^{th} row, n being an integer greater than or equal to 1.

18. The display panel according to claim 17, further comprising a driving circuit;
wherein the driving circuit is connected to the plurality of gate lines and the plurality of data lines on the display substrate; and the driving circuit is configured to provide the gate driving signals to the plurality of gate lines, and to provide the data signals to the plurality of data lines.

19. The display panel according to claim 17, wherein the display panel is one selected from a total reflective type liquid crystal display panel, or a semitransparent type liquid crystal display panel.

20. A display device, comprising a display panel, the display panel comprising an alignment substrate and a display substrate, wherein the display substrate comprises:
a base substrate;
a plurality of gate lines arrayed in row direction and a plurality of data lines arrayed in column direction on the base substrate; and
a plurality of pixel units disposed on the base substrate and arrayed in row direction and in column direction, wherein each of the pixel units comprises a thin film transistor and a pixel electrode, a gate electrode of the thin film transistor being connected to one of the gate lines, a source electrode of the thin film transistor being connected to the one of the data lines, and a drain electrode of the thin film transistor being connected to the pixel electrode;
wherein orthographic projections, on the base substrate, of the gate electrodes and the gate lines connected to the gate electrodes of the thin film transistors in the pixel units in an n^{th} row are spaced apart from orthographic projections, on the base substrate, of the pixel electrodes in the pixel units in the n^{th} row, and orthographic projections, on the base substrate, of the gate electrodes and the gate lines connected to the gate electrodes of the thin film transistors in the pixel units in an n^{th} row are partly overlapped with the orthographic projections, on the base substrate, of the pixel electrodes in the pixel units in an (n+1)^{th} row, n being an integer greater than or equal to 1.
